(19) United States
(12) Patent Application Publication
(10) Pub. No.: US 2002/0150416 A1
(43) Pub. Date: Oct. 17, 2002

(54) Modal computer keyboard stenography emulation apparatus and method

(76) Inventor: Dean VanDruff, Dallas, TX (US)

Correspondence Address: DEAN VANDRUFF, 14220 PIKE ROAD, SARATOGA, CA, 95070, US

(21) Appl. No.: 09/832,915

(22) Filed: Apr. 11, 2001

(51) Int. Cl. B41J 5/12; B41J 5/08

(52) U.S. Cl. 400/103

(57) ABSTRACT

An apparatus and method to change the mode of computer keyboard use from alpha-numeric language orientation to become a stenotype keyboard where the keys change meaning for this purpose is provided. The present invention is unique in that it uses a standard computer keyboard without requiring mechanical changes or modifications. The apparatus and method thus provide the ability to stenotype on any qualified standard or future keyboard as long as appropriate software is installed on the computer.

### BACKGROUND OF THE INVENTION

1. Technical Field

The present invention is directed to emulate a stenography machine on a standard layout computer keyboard. More specifically, the present invention is directed to an apparatus and method to change the mode of computer keyboard use from QWERTY orientation to become a virtual stenography machine where the keys change meaning for this purpose.

2. Description of Related Art

Machine stenographic (steno) typing has evolved into a well-established industry of shorthand language entry. It is primarily used in legal settings such as court reporting, but also for closed-captioning and other applications for the hearing impaired. The format for stenotyping is based on a standard key layout that is well known in the art, which will herein be referred to as stenotype.

The principal skill of stenotyping is mental interpretation: language is broken down into a schema of phonetic or spelling components which are then input by pressing a key or keys on the steno machine. Some common words are input by pressing multiple keys simultaneously.

The actual speed of pressing keystrokes for an expert stenographer is not particularly fast compared to the finger speed of a speed typewriter keyboard typist, as the principle skill of stenotyping is the mental expertise of translation into keystrokes. With this efficiency of movement more than 225 words a minute can be input by an expert stenotypist; about 3-4 times the speed of an expert typewriter typist, and well above the average speed of speech. Due to the inherent advantages of stenotype in inputting human language, it has become standard in court reporting, medical transcription, and other fields where speed and accuracy are critical.

A standard stenotype machine typically costs between 2 thousand and 4 thousand dollars. Given this, typically only professionals such as court reporters can afford such an investment.

Attempts have been made to improve or enhance the fundamental mechanical layout of the stenotype machine, but there is strong momentum to maintain the basic standard. An analogy would be to try to “enhance” or improve the basic piano keyboard; such might appeal to a few, but overall there is a strong impetus to avoid an odd or modified format. As well, the standard stenotype keyboard layout has considerable virtuosity and can be used in ways to provide needed variations without requiring a “new” kind of keyboard. Given this, any “new” format is going to have to fight the tide of tradition for market acceptance in a field where there is little need for change.

Standard steno machines are now routinely coupled to computers. The advantage of coupling with a computer is that the input from the stenotype machine can be interpreted real-time by Computer Aided Transcription (CAT) software and other post-processing software (such as Computer Integrated Courtroom software). Using CAT software a stenotypist can build up a user dictionary of unique keystroke definitions for words, “training” the software over time with custom inputs. The advance of stenotype software in general is important in the context of the present invention because to access such software nearly all in the art still attach an external steno machine to a computer system.

Advanced steno machines have on-board computers that run CAT software within the steno machine itself, which then can display real-time translation on a LCD screen which is built-in. In this case, more computer functions have migrated into the steno machine, further increasing its cost.

A particular invention of note in keyboard hardware is a “hybrid” approach of combining stenography and traditional typing, the only known implementation of which is Eric & Dorothy Goldwasser's U.S. Pat. No. RE34,304, Jul. 6, 1993. This, of course, requires a modified, hybrid, “quasi” keyboard; so it is markedly different from what is hereafter being proposed in the present invention. But since a few of the same objectives are addressed the differences will be highlighted. The Goldwasser's have an apparatus patent that slants the keys in the second and third rows of a modified computer keyboard and puts them at substantially the same height, so that pressing Upper and Lower Bank keys at the same time for stenotyping is made easy. There is also mention in the Goldwasser's patent of a “Stroke Typing System” which appears to allow both regular typing and stenotyping to be done simultaneously, where the computer software figures out which is meant; or alternately using an external foot pedal to designate whether steno or regular typing is meant. This is different from the present invention which is decidedly modal and does not require any additional hardware or simultaneous typing/steno key interpretation software to function. More importantly, the Goldwasser's patent is by definition a special keyboard layout apparatus; not a standard keyboard.

In addition to the hardware cost barrier mentioned earlier, there is a psychological performance barrier for stenotyping as well. Machine steno skill is easy to directly measure, and only those who are exceptionally good at it will be able to pass the high bar of performance required to become a professional. Typical for court reporting schools is that only about 1 in 5 people who start can make the grade. The trouble is: how is a person to know in advance if they will be good enough? An inherent self-confidence is needed at the onset, which is a substantial barrier for many who might otherwise be very good stenotypists. Because of this and the high costs of steno machines, at present the skill of stenotyping is largely a “professional only” concern.

What is needed is a means for interested users to be able to learn and use stenotyping without the need for an expensive steno machine, or custom quasi-steno keyboard, or for that matter any additional hardware investment or addition; and without the idea that they must be extremely good at it for it to be worthwhile to learn. A few examples are: A) the student who wants to take notes of class lectures; B) the businessperson wanting to take full notes of portions of a meeting or business negotiation; C) a person wanting a real-time written record of a telephone conversation; D) the need to write in general at the speed of thought. None of these can reasonably be done with normal typewriting; but neither are these applications of such importance that “overkill” skills are required either. Such users might never be fast enough to work as professional stenographers at the courthouse or to produce close-caption in a live broadcast, but might still make themselves much more productive in life by learning to stenotype.

Additionally, it would be of occasional benefit for professional stenographers to be able to use a standard computer keyboard or notebook computer to stenotype in the case where a steno machine is unavailable or inconvenient for whatever reason. Such a capability (the present invention) is not likely to be preferred by professional stenographers over the tactile superiority of a traditional purpose-built steno machine; but it would make a convenient back-up system, a means to practice, and allow for use of stenotyping skills when a stenotype machine was unavailable or impractical to use. By way of analogy, a traditional steno machine would relate to the present invention the way a grand piano would relate to a plastic organ keyboard: the key layout is basically the same although the proportionate scale is slightly different, and the basic way of “playing” is the same but the feel of the keys is quite a bit different. Now imagine (for the sake of analogy only, of course) that for every grand piano in the world there were on the order of 1000 organ keyboards. It is hoped that this analogy illustrates the convenience and accessibility benefits for professional stenographers to utilize their stenotype skills on standard computer keyboards, even if this will perhaps not be as satisfying in touch and feel as typing on a purpose-built steno machine. Computer keyboards are everywhere and are relatively inexpensive, steno machines are not.

Another background issue of consideration is that the high cost of CAT translation software is related to the current limited “professional” market of customers. If stenotype could be used on any computer without the need for an external steno machine or a customized computer keyboard by users, such a market expansion could potentially lower the resultant software prices needed to recoup the development effort.

Finally, the art of stenotype has long been challenged with the specter that electronic recording media might eventually obviate the need for court-reporters. Nonetheless, the industry has maintained its own; largely because electronic recording is not the same as comprehension, which court reporters can insure by actively interjecting to clarify when needed. But as media improves from mere sound to videotape where recorded fidelity is in most respects as good as being there, then at some point it can be assumed that if it was comprehended by those present at the time then it can be subsequently comprehended by high-fidelity electronic record after the fact as well. In any case, this has been an ongoing debate while the court-reporting industry prospers and grows. Still, it would be good for the industry overall and the art of stenotyping in general to expand beyond courtroom use (by the world's fastest and best) and in relation to the hearing impaired to become a more mainstream skill. The need for speech-speed language input into a computer exists outside of the accuracy critical domain of the legal profession, and it is expected that many users would learn stenotype and benefit from it if they did not have to purchase a special, expensive keyboard to do so.

### SUMMARY OF THE INVENTION

The present invention provides an apparatus and method to change the mode of standard computer keyboard use from alpha-numeric language orientation to become a stenotype input keyboard where the keys change meaning for this purpose.

The present invention implements a best-fit stenotype mapping onto the standard computer keyboard which is unique in that no keyboard mechanical layout or key-shape modifications are required, nor is any other external hardware required to operate. The present invention thus provides the ability to stenotype on a standard computer system and standard computer keyboard.

While the mechanical layout of the standard computer keyboard is less than perfect for stenography, this drawback is offset by the ubiquity and convenience of standard computer keyboards.

In the present invention, the stenography mode is entered into via a programmed command-key sequence, or “hotkey”, and exited the same way, such that normal typing can be interspersed with stenotype in real-time if desired.

The principal benefit achieved is that stenotype can be learned and used on a standard computer system by installing a software program to enable the present invention together with commercially available CAT software or the like; without the need for an expensive steno machine or otherwise modified special keyboard.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1A is an exemplary block diagram of a data processing system in which the present invention may be incorporated, in accordance with one exemplary embodiment of the present invention;

FIG. 1B is an exemplary block diagram of the internal structure of the data processing system shown in FIG. 1A;

FIG. 2 is an exemplary block diagram of the major components of the present invention;

FIG. 3 is an exemplary illustration of a generic stenotype keyboard layout with normal key designations.

FIG. 4 is an exemplary illustration of a generic QWERTY computer keyboard layout within the center keys of interest.

FIG. 5 is an exemplary illustration of the layout of keys in stenography emulation mode for one exemplary embodiment of the present invention;

FIG. 6 is a flowchart outlining an exemplary operation of the present invention.

### DETAILED DESCRIPTION OF THE PREFERRED EMBODIMENT

The present invention provides a mapping of stenography keys onto a standard keyboard, termed: Modal Computer Keyboard Stenography Emulation (MCKSE). The MCKSE methodology makes use of a standard computer keyboard, i.e. a QWERTY keyboard (which refers to the first six letters of a English-language keyboard read from the top left, and is a colloquial way of referring to the standard computer keyboard) as the mechanism to input the stenotype. An example keyboard is the AT keyboard used on many Personal Computers (PC).

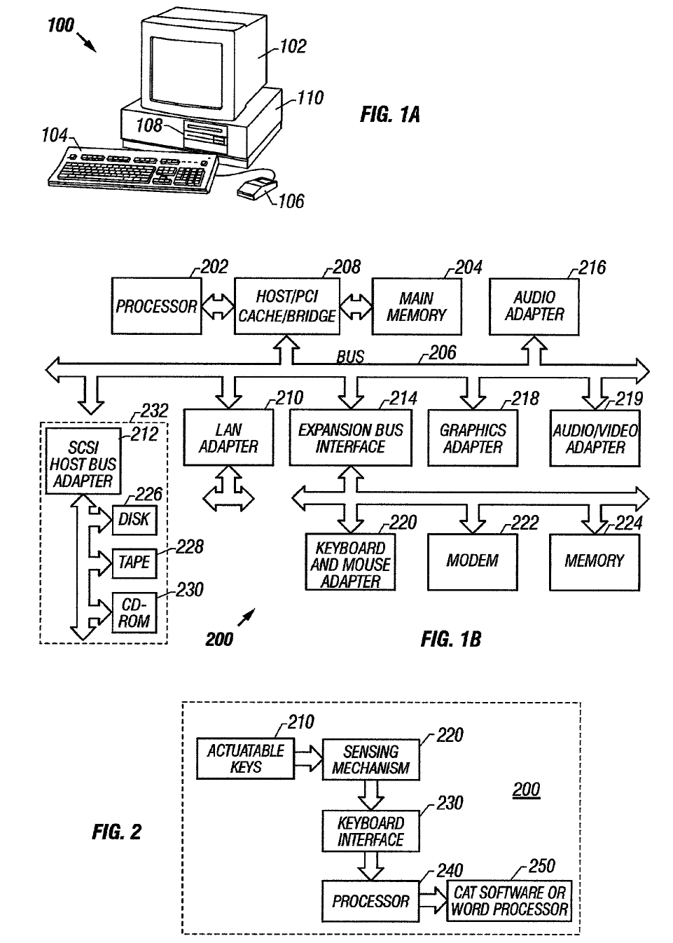

With reference now to the Figures and in particular with reference to FIG. 1, a pictorial representation of a data processing system in which the present invention may be implemented is depicted in accordance with a preferred embodiment of the present invention. A computer 100 is depicted which includes a system unit 110, a video display terminal 102, a keyboard 104, storage devices 108, which may include floppy drives and other types of permanent and removable storage media, and mouse 106. Additional input devices may be included with personal computer 100, such as, for example, a joystick, touchpad, trackball, microphone, external transcription instruments, videotaping machines, and the like. Computer 100 can be implemented using any suitable computer, such as an IBM PC or Apple Macintosh. Although the depicted representation shows a computer, other embodiments of the present invention may be implemented in other types of data processing systems, such as a network computer or notebook computer. Computer 100 also preferably includes a graphical user interface that may be implemented by means of systems software residing in computer readable media in operation within computer 100.

With reference now to FIG. 1B, a block diagram of a data processing system is shown in which the present invention may be implemented. Data processing system 200 is an example of a computer, such as computer 100 in FIG. 1, in which code or instructions implementing the processes of the present invention may be located. Data processing system 200 employs a Peripheral Component Interconnect (PCI) local bus architecture. Although the depicted example employs a PCI bus, other bus architectures such as Accelerated Graphics Port (AGP) and Industry Standard Architecture (ISA) may be used. Processor 202 and main memory 204 are connected to PCI local bus 206 through PCI bridge 208. PCI bridge 208 also may include an integrated memory controller and cache memory for processor 202. Additional connections to PCI local bus 206 may be made through direct component interconnection or through add-in boards. In the depicted example, Local Area Network (LAN) adapter 210, Small Computer System Interface (SCSI) host bus adapter 212, and expansion bus interface 214 are connected to PCI local bus 206 by direct component connection. In contrast, audio adapter 216, graphics adapter 218, and audio/video adapter 219 are connected to PCI local bus 206 by add-in boards inserted into expansion slots. Expansion bus interface 214 provides a connection for a keyboard and mouse adapter 220, modem 222, and additional memory 224. SCSI host bus adapter 212 provides a connection for hard disk drive 226, tape drive 228, and CD-ROM drive 230. Typical PCI local bus implementations will support three or four PCI expansion slots or add-in connectors.

An operating system runs on processor 202 and is used to coordinate and provide control of various components within data processing system 200 in FIG. 1B. The operating system may be a commercially available operating system such as Windows 2000, which is available from Microsoft Corporation. An object oriented programming system such as Java may run in conjunction with the operating system and provides calls to the operating system from Java programs or applications executing on data processing system 200. “Java” is a trademark of Sun Microsystems, Inc. Instructions for the operating system, the object-oriented programming system, and applications or programs are located on storage devices, such as hard disk drive 226, and may be loaded into main memory 204 for execution by processor 202.

Those of ordinary skill in the art will appreciate that the hardware in FIG. 1B may vary depending on the implementation. Other internal hardware or peripheral devices, such as flash ROM (or equivalent nonvolatile memory), or optical disk drives and the like may be used in addition to or in place of the hardware depicted in FIG. 1B. Also, the processes of the present invention may be applied to a multiprocessor data processing system.

For example, data processing system 200, if optionally configured as a network computer, may not include SCSI host bus adapter 212, hard disk drive 226, tape drive 228, and CD-ROM 230, as noted by dotted line 232 in FIG. 1B denoting optional inclusion. In that case, the computer, to be properly called a client computer, must include some type of network communication interface, such as LAN adapter 210, modem 222, or the like. As another example, data processing system 200 may be a stand-alone system configured to be bootable without relying on some type of network communication interface, whether or not data processing system 200 comprises some type of network communication interface.

The depicted example in FIG. 1B and above-described examples are not meant to imply architectural limitations. For example, data processing system 200 also may be a notebook computer or stand-alone keyboard with an LCD display built in. Data processing system 200 also may be a kiosk or a Web appliance. A transcription paper-tape output device may attached as well.

The processes of the present invention are performed by processor 202 using computer implemented instructions, which may be located in a memory such as, for example, main memory 204, memory 224, or in one or more peripheral devices 226-230.

As mentioned above, the present invention makes use of a standard computer keyboard as a means by which a user can input words in stenotype by entering a special “mode” for this purpose. Because the MCKSE enabled computer keyboard acts, in most respects, the same as a standard computer keyboard, a brief description of the manner by which a standard computer keyboard operates will now be provided in order to provide a context in which the present invention may be understood.

A standard computer keyboard operates by providing a matrix of electrical connections below keys which may be actuated by a user. When a user actuates a key, e.g., by pressing the key with the user's finger, the depression of the key causes a short in the electrical connection beneath the actuated key. The short is identified by the computer to which the keyboard is connected as an interrupt command which is continued until the key is released. Based on the position of the key on the keyboard, and thus, the particular electrical connection that is shorted, the computer is able to identify which key was depressed by the user and perform appropriate action, such as display a letter on the display screen corresponding to the letter printed on the actuated key.

The present invention makes use of this standard operation of a keyboard but provides an alternative mapping of the standard computer keyboard such that the keyboard may be used to input stenotype.

FIG. 2 is an exemplary block diagram illustrating the primary components of MCKSE in accordance with the present invention. As shown in FIG. 2, MCKSE operation 200 includes the actuatable keys 210, a sensing mechanism 220 coupled to a keyboard interface 230, a processor 240, and an output to CAT software or other word processing program 250. With the present invention, the physical actuation of keys 210 of the keyboard is detected by the sensing mechanism 220, which generates signals that are sent to the keyboard interface 230.

The keyboard interface 230 interprets the signal as representing a particular keystroke or keystrokes and forwards this information to the processor 240. The processor 240 receives the keystroke information from the keyboard interface and applies a keyboard mapping to the received keystroke(s) information resulting in a stenotype output when MCKSE is selected. Otherwise, it performs as a standard keyboard.

A potential hardware limitation may exist in the unique matrix configuration of particular keyboards for MCKSE usage. Keyboards vary in internal matrix sensing 220 of keys pressed. Because of this, the possibility may exist that some keyboards are not able to sense certain combinations of keys pressed simultaneously. This is termed “masking”, “ghosting” or “blocking”, and most modern keyboards have sufficient matrix coverage to eliminate the problem. The capability of a particular keyboard to operate MCKSE can be tested by simply pressing key combinations 210 to see if all the keys pressed are detected. MCKSE software will thus have a “test mode” to assess the capability of a particular keyboard, and as part of MCKSE product information it may be necessary to list known keyboard compatibility.

The components 210-250 may be incorporated into a stand alone device or may be distributed across a plurality of devices. For example, the actuatable keys 210, sensing mechanism 220 and keyboard interface 230 may be part of a standard computer keyboard while the processor 240 and Computer Aided Transcription 250 may be part of a computer to which the standard computer keyboard is coupled. Alternatively, all of the components 210-250 may be incorporated into a stand-alone computer keyboard that is capable of processing the keystrokes to generate transcription notes or translated words in the manner described hereafter.

The MCKSE mapping of the present invention may be implemented as software, hardware, or a combination of software and hardware. For example, the stenotype mapping may be implemented as software instructions executed by a processor. Alternatively, the stenotype mapping may be hardwired into a hardware circuit through which keyboard input is passed. Moreover, the stenotype mapping of the present invention may make use of a data structure in which received keyboard input may be “looked-up” to determine an appropriate stenographic equivalent. The detected stenography key(s) pressed may be put into a communications format and passed on to CAT or other post-transcription processing software; or such software may be modified or enhanced to interpret MCKSE keystrokes directly. Other implementations of the present invention in software, hardware, or a combination thereof, may be used without departing from the spirit and scope of the present invention.

As well, while the present invention is described and shown in a preferred embodiment on a standard keyboard, MCKSE methodology will be understood to extend to future keyboards and keyboard enhancements as equally protected in so far as the usage is related to MCKSE in particular; unless said enhancement is otherwise or previously patented as a separate, unique innovation.

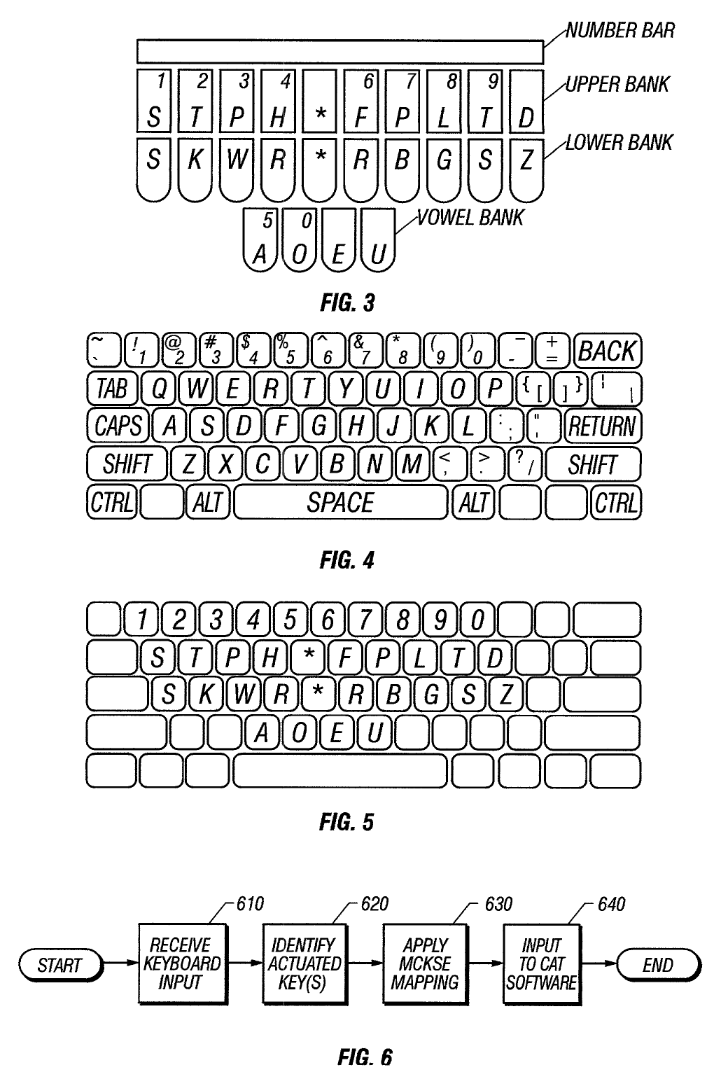

FIG. 3 is an exemplary illustration of a generic stenotype keyboard layout with normal key layout designations.

FIG. 4 is an exemplary illustration of a generic QWERTY computer keyboard layout within the center keys of interest.

FIG. 5 is an exemplary illustration of the particular mapping of the stenotype keys onto the keyboard of the present invention. The designations are well known as a standard within the art, and will thus not be explained for the purposes of the present invention.

The particular mapping of FIG. 5 is thought to be the most obvious and best-fit to emulate the standard steno layout. For example, the home key position (third row down) for touch-typing becomes the Lower Bank “SKWR*RBGSZ” position for stenotyping, and the next row up (second row down) becomes the Upper Bank “STPH*FPLTD” for stenotyping, and so forth.

Steno machines normally do not have designations written on the keys, as stenotype key locations are well known by stenotypists. The designations in FIG. 5, then, are “virtual” and shown as a means to explain how the invention operates. Future keyboards might decide to include such designation in sub or super-text for training, but this is not required.

A drawback in using a standard keyboard for stenotyping is the fact that rows two and three are not perfectly aligned as they are on a traditional stenotype machine. As it turns out, however, the standard computer keyboard layout is fortuitously set up in such a manner as to accommodate MCKSE capability in the format described. Specifically, note that the keys in row two (the QWERTY row of keys in typewriting mode) are offset nearly exactly on-center under the keys in row one (the NUMBERS keys). This is also true with the mechanical relationship between the bottom two rows of keys, rows three (the ASDFGH row) and row four (the ZXCVBN row). But note that the relationship between rows two and three (the two middle rows) is different: between rows two and three the keys are not offset on center but rather offset by about half the distance to center. It is this variation that makes it possible to strike the keys simultaneously between these two rows in emulation of a stenotype machine. While the standard keyboard layout may not be optimal for stenotype, the point is that this variation in key placement does make stenotyping possible. Furthermore, a stenotype machine's Vowel Bank keys are aligned on center in relation to the Lower Bank keys just above, which is the same as the standard computer keyboard layout in the MCKSE mapping shown in the preferred embodiment.

On a traditional steno machine, the “S” and “*” keys are connected between the Upper and Lower Banks, such that pressing either Upper or Lower presses both down. In MCKSE use, either key struck marked as “S” in FIG. 5 (“A” or “Z” in QWERTY shown in FIG. 4) or “*” (“G” or “T” in QWERTY) will be considered an “S” or “*”, respectively.

Two other mechanical differences of interest between FIG. 3 and FIG. 4 are that the computer keyboard keys are square in shape and not elongated like those on a stenotype machines; and they articulate in a slightly different way. But attempting to modify the keyboard to address these differences departs from the objective and benefit of using a standard keyboard. It is felt that any awkwardness of the present invention can be overcome with practice and is more than offset by the ubiquity, accessibility, and convenience of utilization of a standard computer keyboard.

Steno machines have a “number bar” key spanning the top row which if pressed in conjunction with certain other keys changes the meaning of that key to be a number; starting from 1 on the left and going to 9 on the right, with “5” accessed through the “A” key, and “0/zero” accessed through the “O” key. As an option, this may be mimicked as well, where any numbers row key struck in conjunction with the standard format virtual stenokey would serve the same purpose as the number bar on a stenotype machine. Alternately, the numbers keys of the QWERTY format can be used as they are, since the format of these is well known and the placement similar, and only one key needs to be pressed. This second numeric access use is what is shown in FIG. 5. Both options can be enabled simultaneously if desired, as well as the NUM keypad (or not) which is available on most non-notebook computer keyboards (not shown in the Figures) for numeric entry.

In addition to the above emulation layout, the keyboard of the present invention will have a designated key or keys (a “hotkey”) for changing modes from standard computer keyboard input mode to MCKSE mode and back in accordance with the present invention. This mode selection key is not part of the applied stenotype mapping since it is used to enter or exit the MCKSE mode. An example command key sequence to achieve this is suggested as CONTROL+SPACE, but any key or key combination could be used that was deemed convenient by the user.

It should also be apparent by those skilled in the art that other means might be used to switch modes in the present invention, and that those not specifically and previously protected under patent law are thus included in the present invention. Any simple additions of preference or personalization should not be considered departing from the spirit and scope of this invention.

To summarize, the standard computer keyboard does allow adequate stenotyping operation mechanically as described in the preferred embodiment of the present invention. As a result, the skill of stenotyping can be used on a standard keyboard with software that enables MCKSE usage, where the learning curve is to master the slightly different mechanical position and shape of the keys—especially in the offset slanting to the upper left of rows two and three, which correspond virtually to the Lower and Upper Banks respectively. This provides a unique ability for trained stenotypists to utilize their skills on a standard keyboard without changing the basic, normal stenotyping layout. It also provides a means for non-professional users to learn the basic stenotyping skills to use in situations where it is desired to input writing at the speed of speech or thought.

The present invention is not limited to the specific layout set forth in FIG. 5. The embodiment shown is thought to be straightforward and intuitive considering the “home key” positions of both typing and stenotyping, and the overall computer keyboard layout. An example variation might be to shift the entire MCKSE key mapping of FIG. 5 to the right a single key, which would operate otherwise the same. Another example variation would be for those with larger hands—or who otherwise might find the close vertical proximity of the vowel keys a bit difficult for thumb striking—to shift the virtual Upper and Lower Bank keys up one row each, leaving the vowels where they are shown in FIG. 5 just above the space bar. This would replace the numbers keys as shown in FIG. 5, but some stenotypists do not use the numbers keys but instead sound out all numbers; or alternatively the numbers keys in normal stenotype emulation can still be accessed by using the function keys as the virtual numbers bar, as previously described. Shifting both Banks up one row makes simultaneous Upper/Lower Bank key pressing difficult as the two upper rows are centered rather than offset, as noted in the reasoning and rational for the preferred embodiment. But a user may decide to choose this difficulty over that of use of the thumbs in close proximity. The software may allow and include customization like this as would suit the particular user such that slight variations, personalizations, and alternate mappings may be used without departing from the spirit and scope of the present invention.

FIG. 6 is a flowchart outlining an exemplary operation of the present invention. As shown in FIG. 6, the operation starts with receiving a keyboard input from the actuation of a key on the keyboard (step 610). The key that was actuated is determined (step 620) and the MCKSE mapping of the present invention is applied to the keyboard input (step 630). The interpreted keystroke(s) are then output to the CAT or Word Processing (WP) software (step 640). The operation then ends.

The operation outlined in FIG. 6 may be performed with each actuation of a key on the keyboard. Furthermore, if multiple keys are actuated approximately simultaneously, the operation of FIG. 6 is performed for each of the actuated keys at approximately the same time. Thus, the stenotype output will be a combination of each of the keys pressed.

Since the layout of the computer keyboard is not purpose built for stenotyping like a steno machine is, pressing Upper and Lower Bank keys together will be more difficult to achieve with exact simultaneity. In particular, with the mechanical gap between the virtual Upper and Lower Banks the interpretation of keyboard input may need to be “slowed down” in MCKSE mode (step 620) to allow time to see if another key is pressed. An analogy would be the programmability of what constitutes a “double click” on most mouse setup programs. Thus, what is considered “simultaneous” needs to be user programmable to include keys pressed within a certain space of time. A default granularity of MCKSE digitization is suggested as ¼ second, but this should be adjustable to fit the style and skill of the stenographer. Considering the input and interpretation speeds for stenography, this is not thought to be a major drawback considering the advantages of convenience the present invention affords.

Thus, the present invention provides a mechanism for mapping the keyboard strokes of a standard computer keyboard into virtual stenotype. As a result, the user need not purchase an expensive steno machine, or if already purchased need not have such hardware present in every situation in order to transcribe. Further, amateur users can learn to type in shorthand MCKSE mode for note-taking, general writing and other applications without having to purchase an expensive transcription machine. The present invention allows a user to operate a standard computer keyboard as an emulation of a stenograph machine, avoiding the need for non-standard keyboard enhancements or unusual hybrid keyboards. A standard notebook computer with appropriate software can now become a stand-alone, portable, virtual stenotype machine.

The present invention describes the unique MCKSE mode on a standard computer keyboard, and does not extend into the processing of stenotype by subsequent software. It is planned that MCKSE input would operate in conjunction with such software, and in fact make such software more accessible to both professionals and to the general public. It is anticipated that by making it possible for amateurs to learn and use stenotype on a standard computer, and for professionals to use stenotype more conveniently on personal computers, that this increased usage will allow for lower prices on CAT (and other post-processing) software from the present professional costs.

It is important to note that while the present invention has been described in the context of a fully functioning data processing system, those of ordinary skill in the art will appreciate that the processes of the present invention are capable of being distributed in a form of a computer readable medium of instructions and a variety of forms and that the present invention applies equally regardless of the particular type of signal bearing media actually used to carry out the distribution. Examples of computer readable media include recordable-type media such as a floppy disc, a hard disk drive, a RAM, and CD-ROMs and transmission-type media such as digital and analog communications links.

While MCKSE input will normally be interpreted by and stored into computer software directly, it may also be used to output stenographic codes or phonetic symbols on traditional paper-tape as well for the sake of fitting in with court-reporting procedures.

The description of the present invention has been presented for purposes of illustration and description, but is not limited to be exhaustive or limited to the invention in the form disclosed. Modifications and variations will be apparent to those of ordinary skill in the art.

The embodiment was chosen and described in order to best explain the principles of the invention, the practical application, and to enable others of ordinary skill in the art to understand the invention for various embodiments with various modifications as are suited to the particular use contemplated. While the invention has been particularly shown and described with reference to a preferred embodiment, it will be understood by those skilled in the art that various changes in form and detail may be made therein without departing from the spirit and scope of the invention.

What is claimed is:

1. A method of inputting stenotype with a standard computer keyboard, comprising:
mapping keys of the computer keyboard to an approximate stenotype layout;
identifying an actuation of at least one key of the standard computer keyboard; and
passing the resultant stenotype information to subsequent functions and processing.

2. The method of claim 1, wherein the computer keyboard is a QWERTY keyboard where the physical layout is similar to a standard AT keyboard; or is a split-keyboard; or is in general set up like a traditional typewriter in the center keys.

3. The method of claim 1, wherein the keyboard can be switched back and forth between stenotyping and normal typing and computer use by pressing a specified key or grouping of keys.

4. The method of claim 1, wherein the resultant stenotype information is passed on to other software packages or software functions.

5. The method of claim 1, wherein the detection of stenotype keys is imbedded within software packages or software functions.

6. The method of claim 1, wherein the resultant stenotype information is output to either a paper tape device or disk, or both.

7. The method of claim 1, wherein the method is implemented in a stand-alone computer keyboard.

8. An apparatus for inputting stenotype with a standard computer keyboard, comprising:
a keyboard having a plurality of actuatable keys;
a processor coupled to the keyboard; and
either a paper tape output is coupled to the processor, and/or detected keystrokes are passed on to subsequent software or software functions, wherein the processor identifies an actuation of at least one key of the plurality of keys, maps the at least one key of the computer keyboard to stenotype input, and instructs the hardware or software that such keystrokes have been input.

9. The apparatus of claim 8, wherein the computer keyboard is a QWERTY keyboard where the physical layout is similar to a standard AT keyboard; or is a split-keyboard; or is in general set up like a traditional typewriter in the center keys.

10. The apparatus of claim 8, wherein the keyboard can be switched back and forth between stenotyping and normal typing and computer use by pressing a specified key or grouping of keys.

11. The apparatus of claim 8, wherein the resultant stenotype information is passed on to software packages or software functions.

12. The apparatus of claim 8, wherein the detection of stenotype keys is directly imbedded into separate software packages or software functions.

13. The apparatus of claim 8, wherein the resultant stenotype information is output to either a paper tape device or disk, or both.

14. The apparatus of claim 8, wherein the apparatus is a stand-alone computer keyboard.

15. The apparatus of claim 8, wherein the apparatus is distributed between a computer keyboard and a computing device.

16. A computer program product in a computer readable medium for outputting stenotype with a standard computer keyboard, comprising:
first instructions for identifying an actuation of at least one key of the computer keyboard;
second instructions for mapping the at least one key of the computer keyboard to stenotype; and
third passing information of detected stenotype inputs to either a paper tape output which is coupled to the processor, and/or the information is passed on to subsequent software or software functions, wherein the processor identifies an actuation of at least one key of the plurality of keys, maps the at least one key of the computer keyboard to stenotype input, and instructs the hardware or software that such keystrokes have been input.

17. The apparatus of claim 16, wherein the computer keyboard is a QWERTY keyboard where the physical layout is similar to a standard AT keyboard; or is a split-keyboard; or is in general set up like a traditional typewriter in the center keys.

18. The apparatus of claim 16, wherein the keyboard can be switched back and forth between stenotyping and normal typing and computer use by pressing a specified key or grouping of keys.

19. The apparatus of claim 16, wherein the resultant stenotype information is passed on to subsequent software packages or software functions.

20. The apparatus of claim 16, wherein the detection of stenotype keys is directly imbedded into separate software packages or software functions.

21. The apparatus of claim 16, wherein the resultant stenotype information is output to either a paper tape device or disk, or both.

22. The apparatus of claim 16, wherein the apparatus is a stand-alone computer keyboard.

23. The apparatus of claim 16, wherein the apparatus is distributed between a computer keyboard and a computing device.
